(19) United States
(12) Patent Application Publication
(10) Pub. No.: US 2005/0217523 A1
(43) Pub. Date: Oct. 6, 2005

(54) Sheet-fed printing press

(75) Inventors: Peter Hachmann, Dossenheim (DE); Jurgen Albrecht, Eppelheim (DE); Rolf Muller, Nussloch (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/080,615

(22) Filed: Mar. 15, 2005

(30) Foreign Application Priority Data
Apr. 2, 2004 (DE) 20 2004 005480.9

(51) Int. Cl. B41F 23/04

(52) U.S. Cl. 101/424.1

(57) ABSTRACT

A sheet-fed printing press contains a hot air dryer having air nozzles. A nozzle center spacing that exists between adjacent air nozzles and a nozzle effective distance that exists between the air nozzles and a printing material sheet to be dried are in a ratio that is from 0.750 to 2.500.

### BACKGROUND OF THE INVENTION

Field of the Invention:

The present invention relates to a sheet-fed printing press containing a hot air dryer having air nozzles.

In sheet-fed printing presses, printing material sheets are transported past the hot air dryer by a cylinder or chain conveyor, the hot air dryer drying the sheet in the process. In the case of transport by the cylinder, the circumferential surface of the latter on which the sheet lies is a sheet guiding surface. In the case of transport by the chain conveyor, a flat or shell-shaped guide plate, what is referred to as a sheet guiding plate, is coordinated with the conveyor and forms the sheet guiding surface. The sheet floats on an air cushion along the guide plate or slides on the latter. In both cases, the air nozzles of the hot air dryer are oriented toward the respective sheet guiding surface, next to which the hot air dryer is disposed.

In conjunction with the air nozzles, two parameters, inter alia, are of significance for the effective functioning of the dryer. First, there is the nozzle center spacing, that is to say the grid dimension of the nozzle grid that contains the air nozzles. Second, there is the nozzle effective distance, that is to say the effective jet length of the air nozzles. The parameters each have an influence on the stability of the sheet run and on the efficiency of the drying. It has previously not been possible to harmonize these parameters sufficiently.

Neither published, European patent application EP 1 270 221 A1, in which a sheet-fed printing press is described which corresponds to the generic type mentioned in the introduction, nor published, European patent application EP 0 364 425 A2, in which a dryer is described having a nozzle effective distance of less than 10 millimeters, solve this problem to a satisfactory degree. International Patent Disclosure WO 01/85455 A1, in which it is described that the nozzle center spacing depends on the dryer size and can be, for example, 25 millimeters, is also not capable of making a real contribution to solving the problem.

### SUMMARY OF THE INVENTION

It is accordingly an object of the invention to provide a sheet-fed printing press that overcomes the above-mentioned disadvantages of the prior art devices of this general type, in which the stability of the sheet run and the efficiency of the drying are optimized.

The inventive sheet-fed printing press, contains a hot air dryer with air nozzles. A nozzle center spacing that exists between adjacent air nozzles and a nozzle effective distance that exists between the air nozzles and a printing material sheet to be dried are in a ratio that is from 0.750 to 2.500. The quotient that results from dividing the nozzle center spacing by the nozzle effective distance is therefore at least 0.750 and at most 2.500.

Accordingly, the nozzle center spacing and the nozzle effective distance are adapted to one another in an optimum manner, with the result that neither the stability of the sheet run suffers from the dryer efficacy nor vice versa. The sheet-fed printing press can operate at a high printing speed that is not restricted by the hot air dryer. The energy consumption of the hot air dryer is minimized. It is also possible to dry coatings of the printing material sheet that are inherently difficult to dry without problems, such as emulsion varnishes with a great layer thickness. Further additional advantages can be seen in the shortening of the sheet transport path within which the hot air dryer acts on the sheet and in the compactness of the dryer, as a result of which installation space is saved in the sheet-fed printing press in each case.

Other features which are considered as characteristic for the invention are set forth in the appended claims.

Although the invention is illustrated and described herein as embodied in a sheet-fed printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a sheet-fed printing press having a hot air dryer according to the invention;

FIG. 2 is a diagrammatic, sectional view of the hot air dryer shown in FIG. 1; and

FIG. 3 is a plan view corresponding to the viewing direction III shown in FIG. 1 of a nozzle grid of the hot air dryer.

### DESCRIPTION OF THE PREFERRED EMBODIMENTS

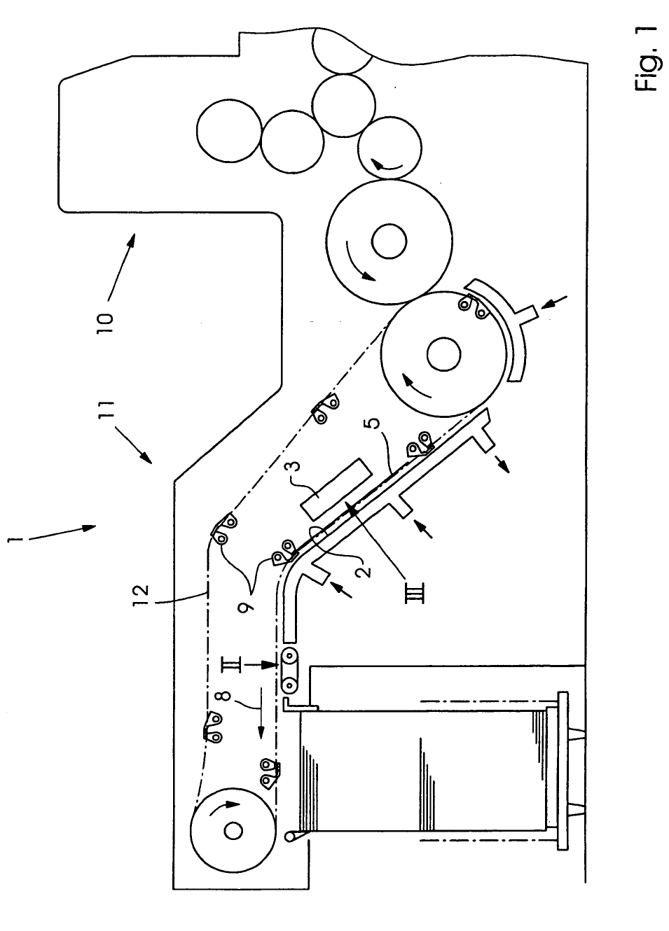

Referring now to the figures of the drawing in detail and first, particularly, to FIG. 1 thereof, there is shown a sheet-fed printing press 1 having a printing unit 10 for lithographic offset printing and a sheet deliverer 11. The sheet deliverer contains a circulating transport device 12 for transporting a respective printing material sheet 5 through between a hot air dryer 3 and a sheet guiding surface 2. The transport device 12 is a chain conveyor of the sheet deliverer 11 and includes at least one gripper bar 9 for holding the printing material sheet 5. A movement path 8 of the gripper bar 9 that determines the sheet running direction 15 runs along the sheet guiding surface 2. The sheet guiding surface 2 is situated on a flat guide plate and is configured so as to guide the printing material sheet 5 in a contactless manner. In order to guide the printing material sheet pneumatically, the sheet guiding surface 2 is configured as a blowing nozzle surface which produces a blown air cushion between itself and the printing material sheet 5 which bears the printing material sheet 5. This is advantageous with regard to smear free transport of the printing material sheet 5 in the case of recto and verso printing operation of the sheet-fed printing press 1 and thus in the case of double-sided printing of the printing material sheet 5. In the other case, in a pure recto printing operation, the blown air cushion is deactivated, with the result that the printing material sheet 5 slides on the sheet guiding surface 2. The sheet guiding surface 2 is therefore also configured so as to guide the printing material sheet 5 by making contact with it.

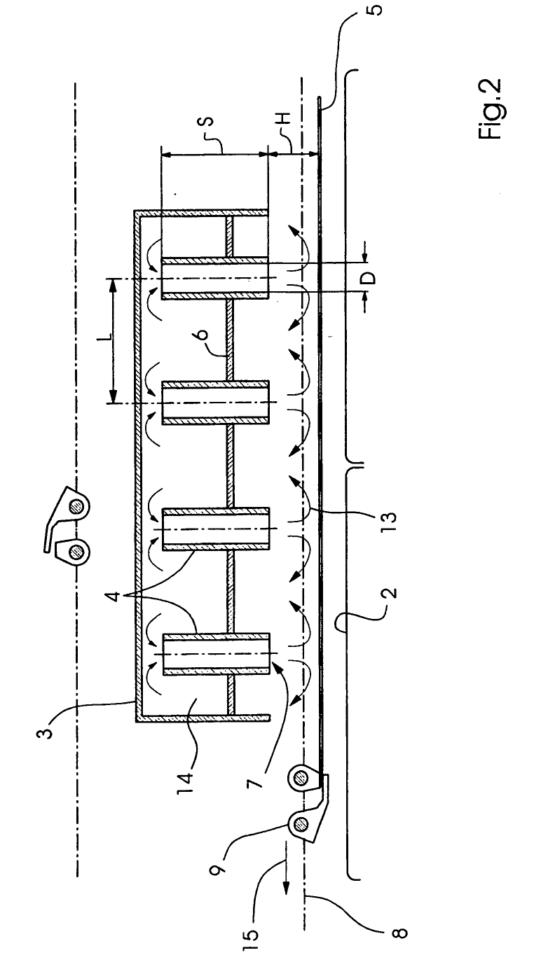

As shown in FIG. 2, the hot air dryer 3 has air nozzles 4 and emits hot air 13 onto the passing printing material sheet 5 from the air nozzles 4. The air nozzles 4 are configured as nozzle tubes and are inserted into a nozzle plate 6 in such a way that, with respect to the hot air dryer 3, a tube piece of the nozzle tube protrudes inwardly and outwardly in each case. This partial sinking of the nozzle tubes into an air chamber 14 which delivers the hot air 13 advantageously makes it possible to achieve a long nozzle length S with external dimensions of the hot air dryer 3 which nevertheless remain compact. The compactness of the hot air dryer 3 is advantageous with respect to its integration between the forward running chain run and the backward running chain run of the chain conveyor. Moreover, the sinking of the nozzle tubes makes it possible to enlarge the air chamber 14 with the overall dimensions of the air chamber 14 and the air nozzles 4 together remaining constant, this enlarging being advantageous with regard to reducing the inflow speeds of the hot air 13 and its distribution. The length of the protruding tube piece is reduced by the presence of the tube piece of the respective air nozzle 4 which protrudes into the air chamber 14, as a result of which in turn the air displacement caused by the gripper bar 9 during its run is improved.

The air nozzles 4 are configured as what are known as round nozzles with circular nozzle openings 7 which determine a nozzle diameter D. The tube or nozzle length S and the nozzle diameter D are in a ratio S:D which is from 1 to 20, preferably from 3 to 10, and, for example, is approximately 5, which is advantageous in flow technology terms in conjunction with the drying.

With regard to unimpeded flowing away of the hot air 13 after it strikes the printing material sheet 5, it is advantageous for the nozzle diameter D and a nozzle effective distance H to be in a ratio D:H which is from 0.075 to 0.375, preferably from 0.125 to 0.250, and, for example, is approximately 0.188. The nozzle effective distance H should be measured between the outlet openings or nozzle openings 7 of the air nozzles 4 and the printing material sheet 5 onto which the air nozzles 4 are oriented. The transport device 12 and the hot air dryer 3 are placed next to one another in such a way that the nozzle effective distance H is ensured.

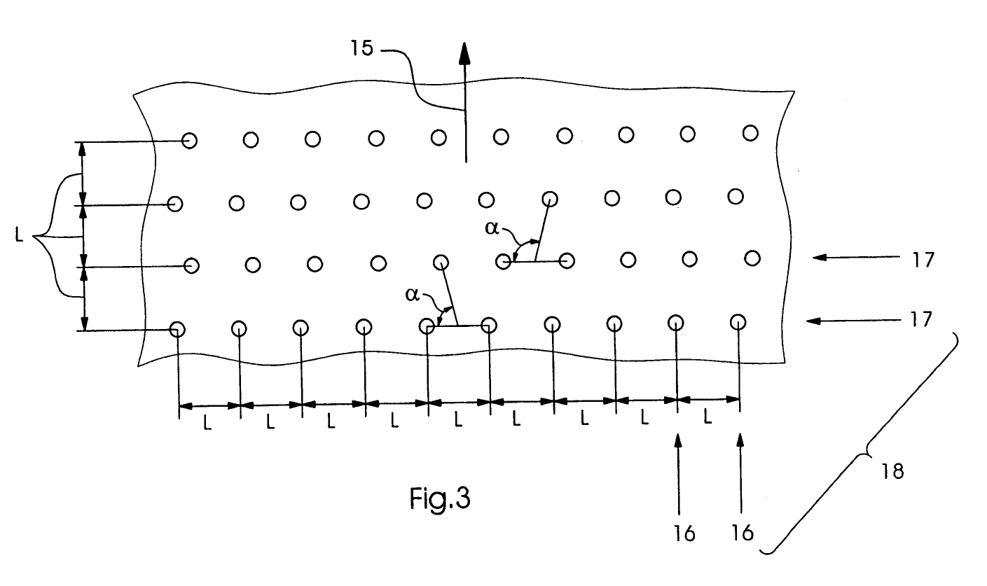

A further parameter that is important for the function is a nozzle center spacing L, at which respectively adjacent air nozzles are situated with respect to one another within longitudinal rows 16 and within transverse rows 17 of a nozzle grid 18 (see FIG. 3). The nozzle center spacing L should be measured between the individual consecutive air nozzles 4 of the longitudinal row 16 in the direction parallel to the sheet running direction 15 and between successive air nozzles 4 of the respective transverse row 17 in the direction perpendicular to the sheet running direction 15. The nozzle center spacing L and the nozzle effective distance H are in a ratio L:H which is from 0.750 to 2.500, preferably from 1.125 to 1.750, and, for example, is approximately 1.375. The nozzle center spacing L can vary slightly within the nozzle grid 18 and, for example, be slightly different within the longitudinal rows 16 than within the transverse rows 17. The nozzle effective distance H can also be slightly different from air nozzle 4 to air nozzle 4. If the two air nozzles 4 which are selected from the nozzle grid 18 in the respective case to determine the ratio L:H and between which there is the nozzle center spacing L have slightly different nozzle effective distances H than one another, each of these nozzle effective distances H must result in the ratio. The nozzle center spacing L and the nozzle effective distance H can also be average or mean values for the nozzle grid 18.

FIG. 3 shows that the transverse rows 17 are offset in the transverse direction with respect to one another rhythmically or alternately in such a way that triangular formations are formed in each case from three air nozzles 4, which air nozzles 4 form corner points of approximately isosceles or at least approximately equilateral imaginary triangles. An angle a between a side of the respective triangular formation which is aligned with the respective transverse row 17 and a median line related to the triangle side is from 60° to 120°, preferably from 75° to 105°, and, for example, is approximately 90°. In the last mentioned case, the nozzle grid 18 would be what is known as a chessboard pattern. In the example shown, the angle α is 76° in one transverse row and 104° in the subsequent transverse row. The nozzle row offset is advantageous with regard to uniform coverage of the printing material sheet 5 with the hot air 13.

According to modifications that are not shown in the drawing, it is also possible to configure the sheet guiding surface 2 in the shape of a curved, shell-shaped guide plate instead of as a flat guide plate. Furthermore, it is conceivable to configure the transport device 12 as a sheet transport cylinder (for example, as an impression cylinder) instead of as a chain conveyor. In this context, the sheet guiding surface 2 would also be understood as being a sheet transport surface on which the printing material sheet 5 which is to be dried lies fixedly, that is to say without moving relative to the sheet transport surface or sheet guiding surface. The sheet guiding surface 2 would therefore be a constituent part of the transport device 12, in the form of the circumferential surface of the sheet transport cylinder. The sheet transport cylinder would hold the printing material sheet 5 firmly with its gripper bar 9 and guide it past the hot air dryer 3 which in this case is oriented onto the sheet transport cylinder or the printing material sheet 5 which lies on the latter.

This application claims the priority, under 35 U.S.C. § 119, of German patent application No. 20 2004 005 480.9, filed Apr. 2, 2004; the entire disclosure of the prior application is herewith incorporated by reference.

1. A sheet-fed printing press, comprising:
a hot air dryer having air nozzles, a nozzle center spacing existing between adjacent ones of said air nozzles and a nozzle effective distance existing between said air nozzles and a printing material sheet to be dried are in a first ratio of 0.750 to 2.500.

2. The sheet-fed printing press according to claim 1, wherein said first ratio is from 1.125 to 1.750.

3. The sheet-fed printing press according to claim 1, wherein said air nozzles have a nozzle diameter, said nozzle diameter and said nozzle effective distance have a second ratio of 0.075 to 0.375.

4. The sheet-fed printing press according to claim 3, wherein said second ratio is from 0.125 to 0.250.

5. The sheet-fed printing press according to claim 3, wherein said air nozzles have a nozzle length, said nozzle length and said nozzle diameter are in a third ratio which is from 1 to 20.

6. The sheet-fed printing press according to claim 5, wherein said third ratio is from 3 to 10.

7. The sheet-fed printing press according to claim 1, wherein:
said hot air dryer has a nozzle plate; and
said air nozzles are nozzle tubes inserted into said nozzle plate.

8. The sheet-fed printing press according to claim 1, wherein said air nozzles are round nozzles with circular nozzle openings formed therein.

9. The sheet-fed printing press according to claim 1, further comprising:
at least gripper bar; and
a sheet guiding surface, a movement path of said gripper bar runs along said sheet guiding surface.

10. The sheet-fed printing press according to claim 9, wherein said sheet guiding surface coordinated with said hot air dryer is configured so as to guide the printing material sheet in a contactless manner.

11. The sheet-fed printing press according to claim 9, wherein said sheet guiding surface coordinated with said hot air dryer is configured so as to guide the printing material sheet by making contact with the printing material sheet.
